(19) United States
(12) Patent Application Publication
(10) Pub. No.: US 2008/0079256 A1
(43) Pub. Date: Apr. 3, 2008

(54) Color Samples and Collector of Color Samples Adapted for Presenting Surface Dyes in Building and Architectural Fields

(76) Inventor: Antonio Cantarella, Cavenago Brianza (MI) (IT)

Correspondence Address: NEXSEN PRUET, LLC, P.O. BOX 10648, GREENVILLE, SC, 29603, US

(21) Appl. No.: 11/830,032

(22) Filed: Jul. 30, 2007

(30) Foreign Application Priority Data
Oct. 2, 2006 (IT) 06425674.6

(51) Int. Cl. B42D 15/00

(52) U.S. Cl. 283/56

(57) ABSTRACT

A color sample or collector (1) of color samples is described, adapted for presenting surface dyes, of a type comprising a paper support (2) of color tablets (6); such samples or collector (1) is adapted to reproduce the same physical and chemical characteristics of a reference substance for the dyes.

### CROSS REFERENCE TO RELATED APPLICATIONS

The present application claims the benefit of priority of Italian Application No. 06425674.6, filed Oct. 2, 2006, which is incorporated herein by reference.

### STATEMENT REGARDING FEDERALLY SPONSORED RESEARCH OR DEVELOPMENT

Not applicable.

### REFERENCE TO A SEQUENCE LISTING, A TABLE, OR A COMPUTER PROGRAM LISTING COMPACT DISC APPENDIX

Not Applicable.

### BACKGROUND OF THE INVENTION

The present invention deals with color samples and a collector of color samples used when presenting wall dyes, with particular use in building and architectural fields.

The product of the present invention falls within the category of color samples used for presenting dyes with an industrial use in various sectors, such as the motor vehicle and the building sectors.

Presentation of color samples uses presentation means such as color folders that contain different color tablets, anchored to the paper supporting base through adhesives.

Another presentation means includes color bundles shaped as a fan, whose pages contain one or more colors and a pin constraining the fan pages aids putting together colors with different color grades.

Various types of color exhibitors exist. An example is a vessel with different color bundles, placed in suitable housings that facilitate extracting the bundle with preferred color from contiguous bundles.

The technology for applying colors to paper supports and vessels with several shapes and materials, coupled with displaying methods and systems, refers, in particular to the technologic class of devices for presenting samples (G09F 5/04: cards of samples and books of samples; G09F 3/00 Labels, tag tickets, or similar identification or indication means; G09F 3/02 Forms or constructions). Secondly, the technology of color and displaying methods involves the following technologic branches: chemical-physical composition of coatings (CO9D Coating Compositions, e.g. paints, varnishes, etc.); copying and printing processes (B41M printing, duplications, marking or copying processes; color printing); and photosensitive material (G03C photosensitive materials for photographic purposes).

Prior means for presenting color samples for industrial use are based on the treatment of substances whose colors are diluted in a chemical solvent (solvent-borne paint), diluted in water (water-borne paint). These substances used for reproducing the color to be shown to customers have compatibility problems with the physical-chemical nature of the basic support that, in this case, is of the paper type.

In fact, colors diluted in a chemical solvent have the inconvenience of having to reproduce and imitate the sample of reference color, this latter one usually being of the water-diluted type. Consequently, the physical nature of color tablets is different from the consistency of the substance used in practice. This aspect becomes important in some commercial sectors, first of all the architectural and building sectors. For example, the representation of the color adapted to coat a wall of a house or an external wall of a structure requires, in addition to an optical knowledge, a tactual knowledge. The latter can be given by some physical characteristics such as density and above color tablet roughness.

Color tablets diluted in water do not solve the interaction problem with the paper support since water, being present in the color tablet, disrupts the characteristic hydrogen bond of electric interaction between cellulose fibers and macro-molecules. Prior means, in fact, to avoid foliating the paper composing the basic bottom of water-diluted color tablets, use the density increase of the color tablet substance, reducing the amount of water in contact with the sheet, modifying the physical consistency of the color tablet with respect to the real reference color. Also in this case, the color tablet is an imitation of the real color.

To avoid disrupting the paper, one uses water-based products whose volume percentage is much lower than the volume percentage of the colored substance. This implies realizing a very dense and pasty composite that is able to limit the water disrupting action that can get in contact with the paper bottom.

On the other hand, such high density and pasty composite has a high thickness and an edge irregularity. This generates burrs on the color tablet and limits the working conditions of the paper support, in particular cutting during finishing and preparing steps of the demonstration product of the samples.

Accordingly, there exists a need for a more effective color sample and collector of color samples adapted for presenting surface dyes in building and architectural fields.

### SUMMARY OF THE INVENTION

The following presents a simplified summary of the invention in order to provide a basic understanding of some aspects of the invention. This summary is not an extensive overview of the invention. It is not intended to identify key or critical elements of the invention or to delineate the scope of the invention. Its sole purpose is to present some concepts of the invention in a simplified form as a prelude to the more detailed description that is presented hereafter.

The problem of physical-chemical incompatibility with the color table, being diluted in water, has been solved with the present invention, as claimed in claim 1, by adopting samples or color collectors on a paper base containing tables reproducing the color with the physical and chemical characteristics of the color used on the surface used in building and architectural fields, in particular complying with roughness and opacity or brightness characteristics of real paint, the basic paper bottom or support being previously treated with a coating that operates as bearing or the color tablets, performing the separating and insulating functions between paper bottom and color tablet.

The invention is described in detail with reference to the color bundle, without thereby limiting the scope of the invention, that, instead, must be meant as extended to the different types of presenting colors defined at the beginning of this specification. The present invention will be better described by a preferred embodiment thereof, provided as a non-limiting example with reference to the enclosed figures, in which:

### BRIEF DESCRIPTION OF THE DRAWINGS

FIG. 1 is a drawing of the color bundle 1 formed of supporting pages 2 for transverse bands of color tablets 6.

FIG. 2 is a drawing of the view of part of the transverse band of the color tablet 6 in which the various color layers and the pre-treatment layer are pointed out.

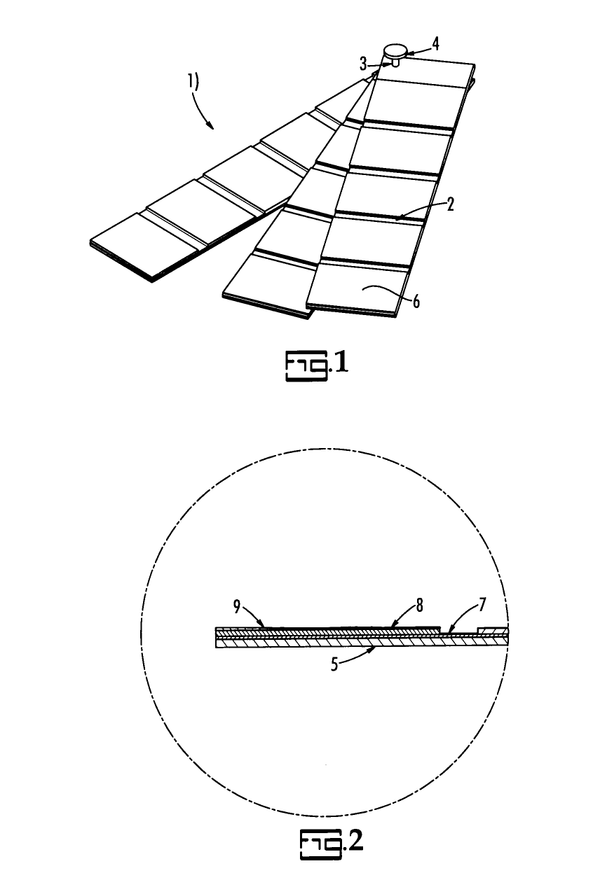

### DETAILED DESCRIPTION OF THE INVENTION

A color bundle 1, used for presenting samples of industrial colors for architecture and buildings, can be made shaped as a fan whose pages 2 contain the color tablets with different grades arranged as transverse bands 6.

A pin 4 constrains the block of pages 2 to a hole 3 drilled on the edge of each page 2, favoring the color approach of two or more pages 2 by angularly rotating the pages 2 with respect to the hole 3.

Each rectangular paper base 5 is previously treated by means of a transparent protecting primer layer 7 which is solvent born paint (normally nitrocellulose).

Such transparent layer 7 operates as an intermediary between paper composing the rectangular base 5 and different transverse bands 6 composing the different color tablets. For such purpose, the color tablet 6 is laid onto the primer 7 surface, forming at least one water-diluted color layer 8.

In particular, for samples used in the motor vehicle (car refinish/automotive) field, a layer of transparent finish 9 covers the water-diluted color layer 8. The transparent primer 7 is preferably a solvent-based product.

The water-diluted color layer 8 is the exact reference paint that is used in the building and architectural fields, and it includes the same roughness and density characteristics are the reference paint. The term “reference paint” refers to the actual paint that will be used on the building materials employed in the architectural and construction fields.

Both the transparent primer 7, and the water-diluted color layer 8 are laid on the surface of a page 2, by spreading them or, optionally, by spraying them. The same occurs for the finish coating 9.

The invention of the present specification addresses the problem of disruption of cellulose fibers composing the paper base 5. At the same time it allows the immediate use of paint used in the building and architectural fields, whichever the consistency and physical nature thereof, allowing to present the color and complying with very high density and roughness characteristics, typical of architectural and building sectors.

At execution level, the invention allows removing the costly process for preparing the color and imitating the desired color. The immediate use of a real reference color for forming color samples or collectors of color samples removes the step of imitating the color with different substances from those of the real color.

What is claimed is:

1. Color samples or collector (1) of color samples adapted for presenting surface dyes, of a type comprising: a paper support (2) for color tablets (6), which are adapted to reproduce the same physical and chemical characteristics of a reference substance for said surface dyes.

2. Color samples or collector (1) of color samples according to claim 1, wherein said paper support (2) includes a paper base (5) and an intermediate paper pre-treatment layer (7) that separates said paper base (5) from said color tablets (6).

3. Color samples or collector (1) of color samples according to claim 2 wherein said intermediate pre-treatment layer (7) is a solvent-based product.

4. Color samples or collector (1) of color samples according to claim 3, wherein said solvent-based product is nitrocellulose paint.

5. Color samples or collector (1) of color samples according to claim 1, wherein the substance of a color tablets (6) complies with roughness and opacity or brightness characteristics of a real paint.

6. Color samples or collector (1) of color samples according to claim 1, wherein the substance of each of said color tablets (6) belongs to a real color substance.

7. Color samples or collector (1) of color samples according to claim 1, wherein said color sample is shaped as a fan, and wherein said color tablets (6) have different grades arranged as transverse bands (6′).

8. Color samples or collector (1) of color samples according to claim 7, wherein said page support (2)comprises a rectangular paper base (5) that supports said transverse bands (6′).

9. Color samples or collector (1) of color samples according to claim 8, wherein said rectangular paper base (5) is equipped with at least one protecting layer of transparent primer (7), said transparent primer (7) being an intermediary layer between said rectangular paper base (5) and different of said transverse bands (6′), wherein different transverse bands (6′) correspond to different color tablets (6).

10. Color samples of collector (1) of color samples according to claim 9, wherein said color tablets (6) are adapted to be laid onto a surface of the primer layer, forming at least one water-diluted color layer (8).

11. Color samples or collector (1) of color samples according to claim 10, further comprising a transparent finish layer (9) that covers said water-diluted color layer (8).
